(19) United States
(12) Patent Application Publication
(10) Pub. No.: US 2025/0331003 A1
(43) Pub. Date: Oct. 23, 2025

(54) WIRELESS COMMUNICATION METHOD AND USER EQUIPMENT

(71) Applicant: PURPLEVINE INNOVATION COMPANY LIMITED, Hongkong (CN)

(72) Inventor: Chun-Che CHIEN, Hongkong (CN)

(73) Assignee: PURPLEVINE INNOVATION COMPANY LIMITED, Hongkong (CN)

(21) Appl. No.: 19/206,072

(22) Filed: May 13, 2025

Related U.S. Application Data
(63) Continuation of application No. 19/115,232, filed on Jan. 1, 0001.
Application No. 19/115,232 is a continuation-in-part of application No. PCT/CN2023/087186, filed on Apr. 8, 2023.
Application No. PCT/CN2023/087186 is a continuation-in-part of application No. PCT/CN2023/087187, filed on Apr. 8, 2023.
Application No. PCT/CN2023/087187 is a continuation-in-part of application No. PCT/CN2023/105099, filed on Jun. 30, 2023.
(60) Provisional application No. 63/377,138, filed on Sep. 26, 2022.

(51) Int. Cl. H04W 72/25; H04W 72/0446; H04W 74/0808

(52) U.S. Cl. CPC H04W 72/25; H04W 72/0446; H04W 74/0808

(57) ABSTRACT

A wireless communication method. A user equipment (UE) derives a length of multiple consecutive slots for a sidelink transmission and selects a resource of a set of multiple consecutive slots from resource candidates in a resource selection procedure according to the derived length of multiple consecutive slots. The UE generates resource reservation information for indicating a resource reserved for the selected resource of the set of multiple consecutive slots, wherein the selected resource is included in the reserved resource. The UE determines whether the reserved resource is valid for sidelink transmission and transmits sidelink data over the reserved resource according to a channel access scheme if the reserved resource is determined to be valid for sidelink transmission.

### CROSS REFERENCE TO RELATED APPLICATIONS

The disclosure is a continuation application of U.S. patent application Ser. No. 19/115,232 filed on Mar. 25, 2025, titled “WIRELESS COMMUNICATION METHOD AND USER EQUIPMENT”, which is a US national phase application based upon an International Application No. PCT/CN2023/121822, filed on Sep. 26, 2023, titled “WIRELESS COMMUNICATION METHOD AND USER EQUIPMENT”, which claims priority to U.S. provisional patent application No. 63/377,138, filed on Sep. 26, 2022, International Application No. PCT/CN2023/087186, filed on Apr. 8, 2023, titled “WIRELESS COMMUNICATION METHOD, USER EQUIPMENT, AND BASE STATION”, International Application No. PCT/CN2023/087187, filed on Apr. 8, 2023, titled “WIRELESS COMMUNICATION METHOD, USER EQUIPMENT, AND BASE STATION”, and International Application No. PCT/CN2023/105099, filed on Jun. 30, 2023, titled “WIRELESS COMMUNICATION METHOD AND USER EQUIPMENT”, which are incorporated by reference in the present application in its entirety.

### BACKGROUND OF DISCLOSURE

### 1. Field of Disclosure

The present disclosure relates to the field of communication systems, and more particularly, to a wireless communication method and a user equipment.

### 2. Description of Related Art

Multi-consecutive slots transmission (MCSt) is a technique for wireless communication that allows a device to transmit data over multiple consecutive slots in a time-frequency resource grid. This technique can improve the coverage and reliability of data transmission, especially in unlicensed frequency bands where interference and channel conditions may vary rapidly.

### Technical Problem

An example of MCSt application is sidelink communication on unlicensed frequency bands, which enables direct transmission between two user equipments (UEs) or between a UE and a network node.

There is a need for achieving high data rates, particularly for eMBB traffic types, while efficiently facilitating a UE's access to a sidelink channel in the unlicensed spectrum. This access should be based on either Mode 1 or Mode 2 resource allocation.

Additionally, there is a requirement for a resource allocation procedure that enables scheduling and transmission over either a single slot or multiple consecutive slots, as applicable to Mode 1 or Mode 2 resource allocation in SL-U.

### SUMMARY

An object of the present disclosure is to propose a user equipment, a base station, and wireless communication method.

In a first aspect, an embodiment of the invention provides a wireless communication method executable in a user equipment (UE), comprising:
deriving a length of multiple consecutive slots for a sidelink transmission;
selecting a resource of a set of multiple consecutive slots from resource candidates in a resource selection procedure according to the derived length of multiple consecutive slots;
generating resource reservation information for indicating a resource reserved for the selected resource of the set of multiple consecutive slots, wherein the selected resource is included in the reserved resource;
determining whether the reserved resource is valid for sidelink transmission; and
   transmitting sidelink data over the reserved resource according to a channel access scheme if the reserved resource is determined to be valid for sidelink transmission.

In a second aspect, an embodiment of the invention provides a UE comprising a processor configured to call and run a computer program stored in a memory, to cause a device in which the chip is installed to execute the disclosed method and any combination of embodiments of the disclosed method.

In a third aspect, an embodiment of the invention provides a wireless communication method for execution by a user equipment (UE), comprising:
initiating a channel occupancy time channel occupancy time (COT);
sharing the COT to at least one UE by transmitting COT sharing information to the at least one UE, wherein the at least one UE selects a resource of a set of multiple consecutive slots from resource candidates in a resource selection procedure according to a derived length of multiple consecutive slots, the at least one UE generates resource reservation information for indicating the resource reserved for the selected resource of the set of multiple consecutive slots, wherein the selected resource is included in the reserved resource that is covered by the COT; and
receiving sidelink data over the reserved resource of the at least one UE.

In a fourth aspect, an embodiment of the invention provides a wireless communication method for execution by a user equipment (UE), comprising:
receiving resource reservation information of at least one UE, wherein the at least one UE generates resource reservation information for indicating the resource reserved;
initiating a channel occupancy time channel occupancy time (COT) that covers a reserved resource of the at least one UE indicated by the resource reservation information;
sharing the COT to the at least one UE by transmitting COT sharing information to the at least one UE, wherein the at least one UE selects a resource of a set of multiple consecutive slots from resource candidates in a resource selection procedure according to a derived length of multiple consecutive slots, wherein the selected resource is included in the reserved resource that is covered by the COT; and
receiving sidelink data over the reserved resource of the at least one UE.

In a fifth aspect, an embodiment of the invention provides a UE comprising a processor configured to call and run a computer program stored in a memory, to cause a device in which the chip is installed to execute the disclosed method and any combination of embodiments of the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

The disclosure introduces an information exchange scheme between the Uu interface and PC5 interface to facilitate the determination or initiation of multi-consecutive slot transmissions.

Providing Mode 1 and Mode 2 resource allocation procedures for realizing single-slot or multiple-consecutive-slots based scheduling and transmission.

Advantageous Effects:

By extending the utilization of resources within a channel occupancy time (COT) window, this approach mitigates collisions and minimizes channel occupation loss due to Listen Before Talk (LBT). As a result, it enhances throughput, meeting the demands of eMBB traffic applications such as augment reality (AR)/virtual reality (VR) gaming, direct vehicle communication, and video streaming in smart home IoT networks.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view showing a wireless communication.

FIG. 2 illustrates a schematic view showing an embodiment of the disclosed method.

FIG. 3 illustrates a schematic view showing another embodiment of the disclosed method.

FIG. 4 illustrates a schematic view showing another embodiment of the disclosed method.

FIG. 5 illustrates a schematic view showing an example of signaling flow that demonstrates the operational roles between the gNB and sidelink UEs.

FIG. 6 illustrates a schematic view showing a COT initiated by UE-A and slots of UE-A and UE-B.

FIG. 7 illustrates a schematic view showing an example showing steps of Mode 2 resource allocation for multi-consecutive slots transmission.

FIG. 8 illustrates a schematic view showing an example of relationships between the first stage SCI in PSSCH, the second stage SCI, PSSCH and TBS.

FIG. 9 illustrates a schematic view showing an example of multiple consecutive slots generation based on configuration of RRI and SL resource reselection counter.

FIG. 10 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The disclosure addresses pending issues in multi-consecutive slots transmission (MCSt) for Mode 1 and Mode 2 resource allocation as well as issues regarding UE reporting a COT or related information to gNB for aiding Mode 1 resource allocation in SL-U.

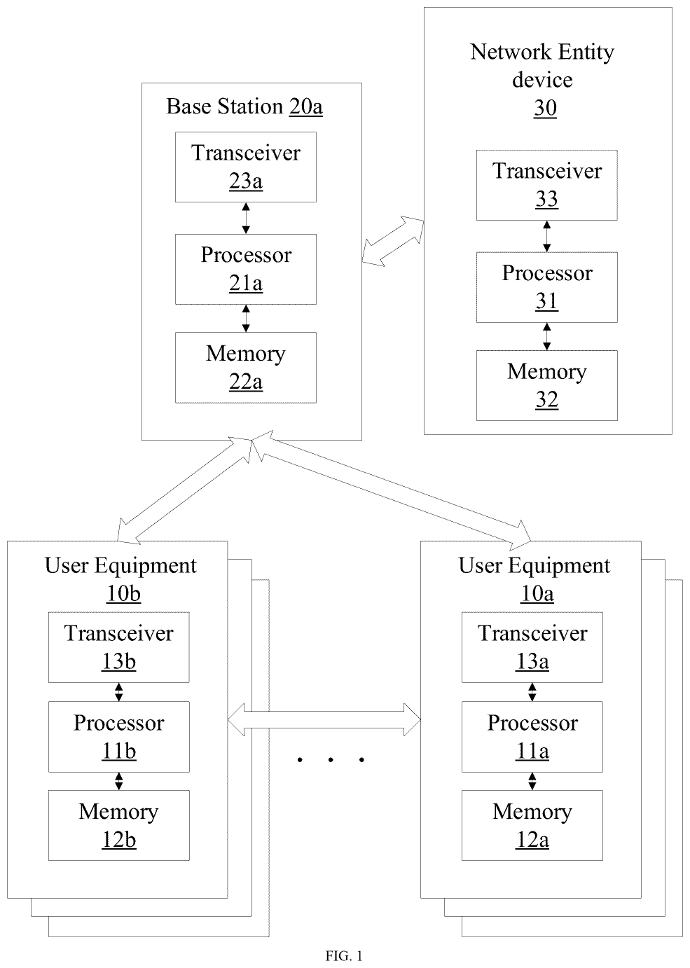

With reference to FIG. 1, a telecommunication system including a user equipment (UE) 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and core network (CN) entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, and transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICS), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Sidelink (SL) transmission of a control signal or data may be a transmission operation from a UE to another UE. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

In the description, a transmitting UE (Tx UE) may be one of the UEs in FIG. 1 which transmits SL transmission (e.g., PSSCH) to a receiving UE (Rx UE). The Rx UE receiving the SL transmission (e.g., PSSCH) may be one of the other UEs in FIG. 1. The PSSCH is referred to as scheduled PSSCH. HARQ feedback in the description, unless elsewhere specified, means an HARQ feedback in response to the scheduled PSSCH. In the description, HARQ feedback can be simply referred to as feedback.

In the description, gNB, unless elsewhere specified, may be an example of the base station 20a. In the embodiments of the disclosure, gNB may be interpreted as a base station, such as an eNB of LTE, a gNB of NR, or a base station beyond 5G.

Embodiments of sidelink hybrid automatic repeat request (HARQ) feedback schemes and corresponding procedures to support the feature of sidelink operation over unlicensed spectrum (SL-U) are provided to exploit commercial use cases requiring a large amount of data exchanges between UEs while not consuming valuable licensed spectrum. In addition to increasing throughput by harvesting additional bandwidth in unlicensed spectrum, compared to NR-Unlicensed (NR-U) with uplink and downlink operation in unlicensed spectrum, SL-U can reduce the latency of data delivery while offloading the traffic from licensed spectrum to unlicensed spectrum. The extensible services or applications for SL-U include direct vehicle communication, augment reality (AR)/virtual reality (VR) gaming, video streaming in smart home Internet of Things (IoT) network, etc. Enhancements of channel access schemes for sidelink operation over the unlicensed spectrum is necessary to meet both sidelink traffic requirements as well as regulatory requirements of listen-before-talk (LBT) in the unlicensed spectrum. Functional improvement of sidelink operation comprising Mode 1 or Mode 2 resource allocation, resource reservation, and HARQ feedback under the framework of LBE-based or FBE-based channel access scheme. The LBE stands for load-based equipment (LBE), and the FBE stands for frame-based equipment (FBE) load-based equipment (LBE) frame-based equipment (FBE)

NR Vehicle-to-Everything (V2X) defines two resource allocation modes for sidelink communications, which are Mode 1 and Mode 2, each of which corresponds to a centralized scheduling scheme and a distributed scheduling scheme, respectively. In Mode 1, radio resources used for sidelink transmissions are scheduled by an eNB. And in Mode 2, UE (e.g., UE 10a or UE 10b) autonomously selects radio resources from a resource pool configured by gNB before performing sidelink transmissions. Mode 1 resource allocation can only operate in the scenarios where the UEs are inside the coverage of gNB. On the other hand, Mode 2 resource allocation is determined and carried out by UE, therefore can operate either inside or outside of gNB's coverage. In NR V2X, physical sidelink control channel (PSCCH) can be used for carrying sidelink channel information (SCI), physical sidelink shared channel (PSSCH) can be used for carrying sidelink data, and PSFCH can be used for carrying HARQ feedback information of sidelink data received in the PSSCH.

The SCI schedules the resources carried by the PSSCH associated to a transport block (TB), as well as information required for decoding the TB. Different from LTE V2X wherein the SCI is only carried in PSCCH, in NR V2X, the SCI is transmitted in two stages. The first stage SCI is carried on the PSCCH while the second stage SCI is carried on the corresponding PSSCH.

The first stage SCI indicates the frequency resources of the PSSCH as well as the resource reservation for up to two retransmissions of the transport block (TB). The first stage SCI also carries modulation and coding scheme (MCS) of the associated PSSCH, a priority of the associated PSSCH, and a format and size of the second-stage SCI. The second stage SCI carries information used for decoding PSSCH and for supporting HARQ feedback and channel state information (CSI) reporting. The second stage SCI indicates source identifier (ID), destination ID, and whether HARQ feedback is enabled for the received PSSCH. The destination ID indicates an intended receiver of a receiver UE (Rx UE) of the TB, source ID allows an Rx UE to determine the identity of transmitter UE (Tx UE) for HARQ feedback carried on PSFCH. The second stage SCI also carries a new data indicator (NDI) redundancy version (RV), and an HARQ process ID of a corresponding TB. The HARQ stands for hybrid automatic repeat request (HARQ). The purpose of splitting the SCI into two stages allows UEs other than Rx UE to decode only the first stage SCI for channel sensing purposes and determine whether a resource is reserved by other Tx UEs, while the second stage SCI provides additional information on TB decoding and feedback for the Rx UE.

To support sidelink radio access to unlicensed bands, LBT and channel occupancy time (COT) acquisition or COT sharing can be introduced to both Mode 1 and Mode 2 resource allocation schemes in the PC5 interface. For Mode 1 resource allocation, UE (e.g., UE 10a or UE 10b in FIG. 1) should carry out a channel access procedure, i.e., LBT, before sidelink transmission on the scheduled resources. In this case, gNB assesses the channel based on measurement and report from UE (e.g., UE 10a or UE 10b) and may schedule sidelink UE (e.g., UE 10a or UE 10b) through a licensed or unlicensed spectrum of Uu interface to allocate sidelink resource in the unlicensed spectrum of PC5 interface. For Mode 2 resource allocation, UE (e.g., UE 10a or UE 10b) should perform channel sensing, resource selection and channel access procedure before sidelink transmission on the unlicensed spectrum. In order to avoid resource collision for shared resource pool in an unlicensed band, a reservation of sidelink resource indicated in SCI for the current or future sidelink transmission in NR-V2X can be carried over to the unlicensed spectrum. Other sidelink UEs can perform SCI monitoring in the resource pool to determine whether a sidelink resource is occupied or available for sidelink transmission. After determining valid resources and performing resource selection according to a certain rule, UE (e.g., UE 10a or UE 10b) may execute LBT to assess channel availability before acquiring a COT for its own sidelink transmission or share the acquired COTs with other sidelink UEs.

In NR-U, two channel access modes are supported, which are LBE (load-based equipment) based channel access mode and FBE (frame-based equipment) based channel access mode. LBE is also known as a dynamic channel access mode, and FBE is also known as semi-static channel access mode. In LBE channel access, a UE (e.g., UE 10a or UE 10b) may perform an LBT at any time instantly whenever the UE has data in the buffer and initiate a COT for transmissions upon successful LBT. On the other hand, for FBE channel access, one or more UEs only contends for the channel based on LBT at synchronized frame boundaries. A fixed frame period (FFP) among {1 ms, 2 ms, 2.5 ms, 4 ms, 5 ms, 10 ms} is assigned for the FBE device. FFP occurs periodically with a channel occupation time (COT) starting from the beginning and followed by an idle period at the end of the FFP.

For unlicensed band channel access, upon a UE (e.g., UE 10a or UE 10b) initiates a channel occupancy time (COT) after a successful Type 1 LBT, the duration for continuous transmission can be up to maximum COT (MCOT), which depends on channel access priory class (CAPC). A burst transmission, which restricts gaps between any two consecutive transmissions at most 16 μs within a COT, can improve channel access efficiency as well as prevent channel lost due to LBT failures in the middle of COT. The burst transmission can comprise consecutive multi-slot transmission within a COT of the same TB or different TBs sent from a UE initiating the COT or from a UE sharing the COT.

In this disclosure, we provide our views on Mode 1 and Mode 2 resource allocations of multi-consecutive slots transmissions. For Mode 1 resource allocation, based on the information provided by UE, gNB can schedule multiple consecutive slots for one or more than one UE, and the UE can determine its LBT scheme based on whether the UE is an initiating UE or a responding UE. For Mode 2 resource allocation, initiating UE can determine and select available candidate resources for scheduling and transmitting multiple consecutive slots to one or more than one UEs upon successful Type 1 LBT procedure. In addition, a target receiver of the initiating UE can share the COT after successful Type 2 LBT to transmit multiple consecutive slots to one for more than one UE including the initiating UE.

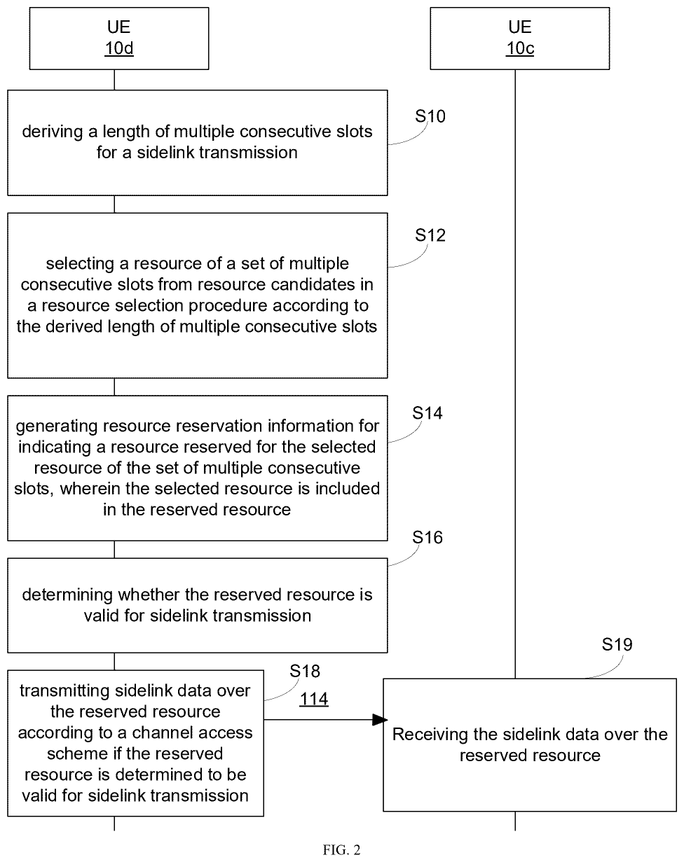

With reference to FIG. 2, a UE 10c and a UE 10d execute an embodiment of a wireless communication method. An example of the UE 10c may include one of the UEs in FIG. 1. An example of the UE 10d may include another one of the UEs in FIG. 1. An example of gNB in the description may include the base station 20a.
The UE 10d derives a length of multiple consecutive slots for a sidelink transmission (S10).
The UE 10d selects a resource of a set of multiple consecutive slots from resource candidates in a resource selection procedure according to the derived length of multiple consecutive shouts (S12).
The UE 10d generates resource reservation information for indicating a resource reserved for the selected resource of the set of multiple consecutive slots, wherein the selected resource is included in the reserved resource (S14).
The UE 10d determines whether the reserved resource is valid for sidelink transmission (S16).
   The UE 10d transmits sidelink data over the reserved resource according to a channel access scheme if the reserved resource is determined to be valid for sidelink transmission (S18). The UE 10c receives the sidelink data over the reserved resource (S19).

In some embodiments of the disclosure, the UE 10d may use a COT shared from another UE, such as the UE 10c. Specifically, the UE 10d may selects the resource of the set of multiple consecutive slots from the resource candidates that are covered by the COT shared from another UE, such as the UE 10c.

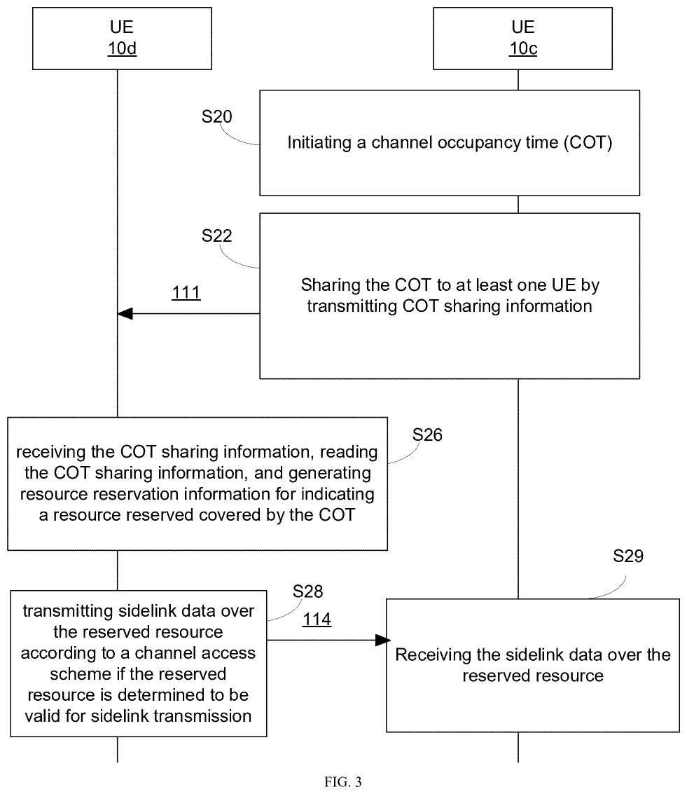

With reference to FIG. 3, the UE 10c initiates a channel occupancy time (COT) (S20) and shares the COT to at least one UE by transmitting COT sharing information to the at least one UE, wherein the COT covers a reserved resource of the at least one UE (S22). When receiving the COT sharing information, the at least one UE (e.g., UE 10d) reads the COT sharing information and uses the COT accordingly. Specifically, the at least one UE (e.g., UE 10d) generates resource reservation information for indicating a resource reserved covered by the COT (S26). The at least one UE (e.g., UE 10d) may perform the aforementioned steps to select a resource and transmits sidelink data over the reserved resource.

The at least one UE (e.g., UE 10d) transmits sidelink data over the reserved resource according to a channel access scheme if the reserved resource is determined to be valid for sidelink transmission (S28). The UE 10c receives the sidelink data over the reserved resource (S29).

In some embodiments of the disclosure, the length of multiple consecutive slots is derived based on a parameter configured for selection of the resource of the set of multiple consecutive slots in the resource selection procedure.

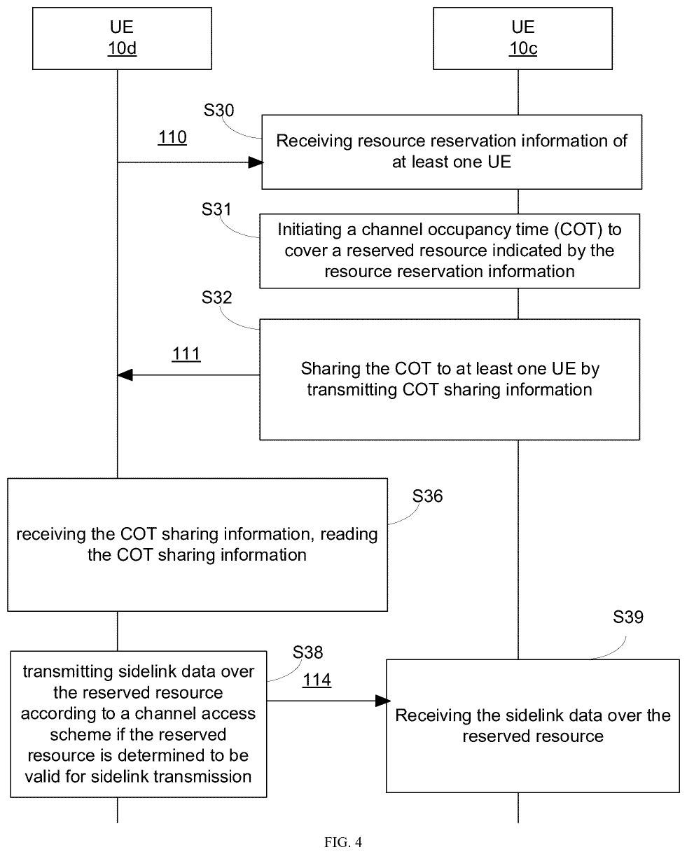

With reference to FIG. 4, at least one UE (e.g., UE 10d) transmits resource reservation information to the UE 10c, and the UE 10c receives the resource reservation information (S30). The UE 10c initiates a channel occupancy time (COT) that covers a reserved resource of the at least one UE (e.g., UE 10d) indicated by the resource reservation information (S31) and shares the COT to at least one UE by transmitting COT sharing information to the at least one UE, wherein the COT covers the reserved resource of the at least one UE (S32). When receiving the COT sharing information, the at least one UE (e.g., UE 10d) reads the COT sharing information and uses the COT accordingly (S36). The at least one UE (e.g., UE 10d) may perform the aforementioned steps to select a resource and transmits sidelink data over the reserved resource.

The at least one UE (e.g., UE 10d) transmits sidelink data over the reserved resource according to a channel access scheme if the reserved resource is determined to be valid for sidelink transmission (S38). The UE 10c receives the sidelink data over the reserved resource (S39).

### Embodiment A

Mode 1 resource allocation procedure for one slot or more than one consecutive slot based scheduling.

### Embodiment A-1

gNB can receive at least one of the following scheduling assistance information from a UE to assist Mode 1 resource allocation
CAPC related information, including at least one of the following:
   DL or UL CAPC table adopted by the UE.
   CAPC value of corresponding traffic type generated by the UE. The CAPC value can link to other parameters such as maximum COT (mCOT), channel access priority, or contention window size, etc.
COT sharing related information, including at least one of the following:
   UE's capability of initiating a COT.
   For a UE capable of initializing a COT, at least one of following information can be provided to the gNB before or after initiating a COT.
      COT sharing information, comprising the starting time, ending time, or length of the COT, which is a time duration available for sharing to another UE.
      Frequency range of a COT sharing, e.g., indexes of one or more than one interlace, subchannel, or RB set.
Identities of one or more than one target Rx UE of a Tx UE.
   The Tx UE can be the UE capable of initiating a COT or the UE sharing initiating UE's COT.
   The target RX UE is the UE capable of detecting Tx UE's COT sharing information in the SCI or the UE scheduled for receiving PSSCH transmitted from the initiating UE.
One or more than one SL channel type to be transmitted in the COT.
   The SL channel type includes PSCCH, PSSCH, PSFCH, or P-SSB.
For a UE capable of performing Mode 2 resource allocation, at least one of the following information can be provided to the gNB
   Resource reservation information.
      The resource reservation information comprises the reserved resource for the UE initiating the COT or the target UE qualified for sharing the COT.
      The resource reservation information comprises time domain resource or frequency domain resource for initial transmission or retransmission of one or more than one TB.
Channel condition related information, including at least one of the following:
   Statistical or dynamic channel access result of Type 1 LBT or Type 2 LBT.
   SL-HARQ feedback for SL unicast or SL groupcast.

### Embodiment A-2

gNB can receive scheduling assistance information from a UE to assist Mode 1 resource allocation based on at least one of the following schemes
The scheduling assistance information transmitted by UE can be carried in UCI over licensed or shared spectrum via PUCCH or PUSCH.
   The scheduling assistance information can be individually encoded in a UCI or jointly encoded with SL HARQ feedback or CG-UCI.
   The scheduling assistance information can be transmitted individually or together with other UE assistance information, e.g., SL traffic type, SL traffic periodicity, SL traffic priority, Maximum TB size, or latency and reliability requirement of a TB, via MAC CE or RRC signaling.

### Embodiment A-3: In Mode 1 Resource Allocation

Based on receiving at least one of the following information, gNB can derive corresponding scheduling parameters relevant to single slot or multiple consecutive slots scheduling and deliver at least one of the corresponding scheduling parameters to UE.
Scheduling request (SR) and/or buffer status report (BSR) transmitted by a UE.
   gNB can rely on this information to determine requested packet size, so as to determine whether to trigger multi-consecutive slots transmission or determine the length of multi-consecutive slots transmission for the UE.
LBT failure indication, SL HARQ-ACK reporting, channel busy ratio (CBR) or channel occupancy ratio (CR) measurement from one or more than one UE to determine a channel congestion condition of a UE. Scheduling schemes in response to the received information can be at least one of the following:
   gNB can rely on this information to determine which UE has a better channel condition, so as to assign suitable resource(s) for that UE to initialize a COT. Other UEs with worse channel conditions can be assigned resource(s) at a location later than the resource location of the better channel condition UE, so that a worse channel condition UE can share the COT based on a short LBT, i.e., Type 2A/2B/2C LBT.
   gNB can rely on this information to determine whether to adjust scheduled resource, e.g., an RB set, or adjust channel access parameter for a UE with worse channel condition.
Priority level, e.g., CAPC value, of one or more than one UE requesting a SL resource, gNB can rely on this information to determine at least one of the following scheduling schemes:
   gNB determines whether multi-consecutive slots transmission should be triggered to increase transmission reliability or data rate for a UE.
      More consecutive slots can be scheduled for a UE with higher priority, such that the UE has more reliable SL transmissions.
   gNB determines CPE length of initial slot of the multiple consecutive slots.
      With a longer CPE length, a higher priority UE can be transmitted earlier and avoid being blocked by transmission of a lower priority UE.
   gNB determines the number of starting points for a UE to perform LBT before accessing the channel.
      UE can have more opportunities to access the channel if Type 1 LBT result in the previous starting point is failed.
Target receiver(s), e.g., UE IDs, of Tx UEs.
   gNB can rely on this information to determine whether data or information exchanging is performed among a pair of UEs or a group of UEs, so as to determine whether to set up a set of multi-consecutive slots transmission for different UEs.
      A UE capable of initiating a COT or a UE sending SR or BSR can provide information of target receiver(s) to the gNB.
      A responding UE sharing a COT or a UE sending SR or BSR can provide information of target receiver(s) to the gNB.
   For responding UE, at least the UE initiating the COT is one of the target receivers for the responding UE.
   For example, if the target receiver of an initiating UE's transmission happens to be a UE sending a scheduling request, and one of the target receiver(s) of the responding UE's transmission(s) is the initiating UE, then:
      Multi-consecutive slots transmission can be scheduled for the initiating UE followed by the responding UE.
      Since the initiating UE is a target UE of the responding UE, gNB can also schedule the responding UE followed by the initiating UE in the same set of multiple consecutive slots.

### Embodiment A-4: For Mode 1 Resource Allocation

gNB can perform multiple consecutive slots scheduling of a SL burst transmission for one or more than one UE based on at least one of the following steps. There is no restriction on combing, dividing, or reordering any of the following steps.
Step 1: gNB receives SR or BSR from one or more than one UE if dynamic scheduling is performed.
Step 2: gNB receives scheduling assistance information for one or more than one UE.
Step 3: gNB derives available COT length for multi-consecutive slots transmission.
Step 4: gNB evaluates whether single slot or multiple consecutive slots are set up for each UE sending SR or BSR according to the received information.
Step 5: If scheduling of multiple consecutive slots is triggered.
   gNB determines one or more than one sets of multiple consecutive slots is created.
      Different UEs may be scheduled to be transmitted in the same set of multiple consecutive slots or different sets of multiple consecutive slots.
         One or more than one UE can be scheduled on the same multiple consecutive slots.
      Different TBs for a UE may be scheduled to be transmitted in the same set of multiple consecutive slots or different sets of multiple consecutive slots.
         One or more than one TB for a UE can be scheduled on the same multiple consecutive slots.
   gNB determines the CPE length applied to the first slot of the set of multiple consecutive slots.
   gNB determines the location of one or more than one starting point of multi-consecutive slots transmission.
   gNB determines to schedule one or more than one starting points for UE to access the channel.
   gNB determines the number of slots of the multi-consecutive slots transmission.
   gNB determines the number of consecutive slots for each of UEs involved in the multi-consecutive slots transmission.
   gNB determines the scheduling order for each of UEs involved in the multi-consecutive slots transmission.
   NB determines the number of TBs to be scheduled for each of UEs involved in the multi-consecutive slots transmission.
      For single TB transmission, a repetition scheme of Type A or Type B, similar to PUSCH for NR-U, for PSSCH transmission over multiple consecutive slots can be applied in SL-U.
      For multiple TBs transmission. Multiple PSSCH transmissions, similar to multiple PUSCH for NR-U, can be applied in SL-U.
Step 6: gNB schedules resource for each UE involved in the multi-consecutive slots transmission
   gNB determines the resource location for each slot of the multiple consecutive slots, including at least one of the following parameters:
      An RB set index for each slot of the multiple consecutive slots.
      One or more than one interlace index or the number of interlaces for each slot of the multiple consecutive slots.
      One or more than one symbol location within each slot of the multiple consecutive slots.
Step 7: gNB transmits the scheduling result to each of the UEs involved in multi-consecutive slots transmission based on dynamic grant (DG) DCI indication or Type 1/Type 2 configured grant (CG) configuration.

### Embodiment A-5: In Mode 1 Resource Allocation

A UE can perform multi-consecutive slots transmission of a SL burst transmission based on at least one of the following example steps. There is no restriction on combing, dividing, or reordering any of the following steps.
Step 1: UE transmits SR or BSR to gNB to request for SL transmission resource.
Step 2: UE provides scheduling assistance information to gNB.
Step 3. UE receives multi-consecutive slots scheduling from gNB based on dynamic grant (DG) DCI indication or Type 1/Type 2 configured grant (CG) configuration.
Step 4: UE determines the channel access scheme according to the resource location of the scheduled SL resource. For example,
   Before the starting point of scheduled SL resource.
      If a COT has not been initiated by any UE or the UE cannot share the COT initiated by another UE, e.g., the UE is not a target receiver of the initiating UE's PSSCH.
         The UE performs Type 1 LBT with parameters associated with a CAPC value to initiate a COT covering the scheduled SL resource
         If the UE can initiate the COT after a successful Type 1 LBT procedure,
         UE can transmit the traffic on the single slot or multiple consecutive slots in the COT according to the resource allocation parameters, e.g., CPE length, number of slots, etc.
         Otherwise, UE can re-perform Type 1 LBT at the next starting point if available.
      Otherwise, if a COT has been initiated by another UE, e.g., indicated in the COT sharing information, and the UE is a target receiver of the initiating UE.
         The UE performs one of Type 2 LBTs indicated by the initiating UE or gNB to access the shared COT covering the scheduled SL resource.
         If the UE can access the shared COT after a successful Type 2 LBT procedure
         UE can transmit the traffic on the single slot or multiple consecutive slots in the COT according to the resource allocation parameters, e.g., CPE length, number of slots, etc.
         One of the target receiver(s) for receiving the scheduled PSSCH transmitted by the UE is the UE initiating the COT.
         UE can identify the initiating UE based on the source ID indicated in the COT sharing information in the first stage SCI or in the second stage SCI on the received PSSCH.
         Otherwise, UE can re-perform Type 2 LBT at the next starting point if available.
Step 5: In the later resource location scheduled by the gNB
   If the gNB schedules resources of another consecutive slots at the later part of the same set of multiple consecutive slots or at a different set of the multiple consecutive slots for the UE within a COT, the UE can perform Type 2 LBT for accessing the COT which is either initiated by the UE itself or by another UE.

### Embodiment A-6

FIG. 5 illustrates an example of a signaling flow to demonstrate the operation roles between gNB and sidelink UEs.

A gNB (e.g., gNB 20) receives a scheduling request in PUCCH from UE-A and UE-B.

gNB receives scheduling assistance information from UE-A.

gNB transmits PDCCH to schedule multiple consecutive slots for UE-A and UE-B based on Mode 1 resource allocation.

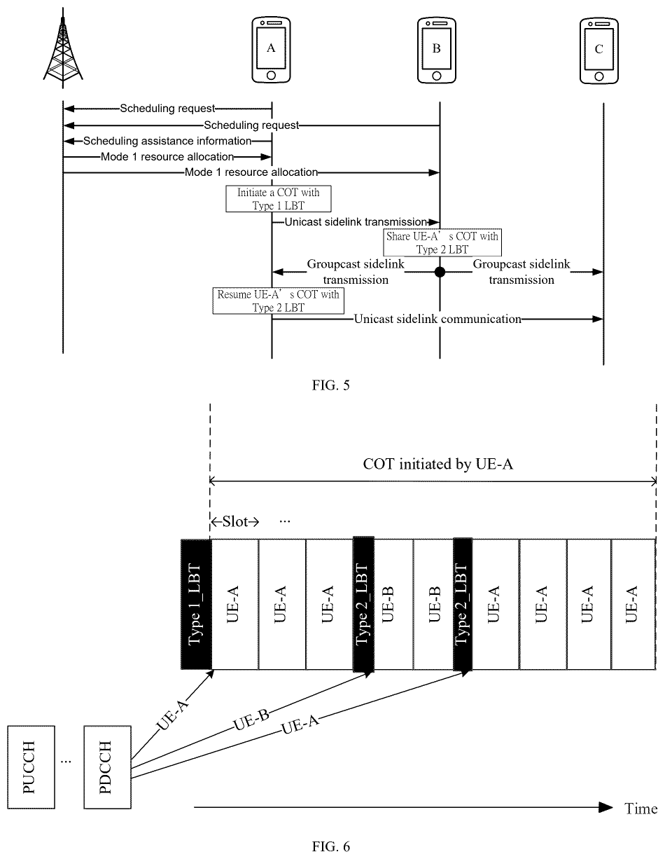

UE-A initiates a COT (e.g., a COT initiated by UE-A in FIG. 6) before scheduled resource with Type 1 LBT and performs unicast SL transmission to UE-B.

UE-B shares the COT initiated by UE-A before scheduled resource with Type 2 LBT and performs groupcast SL transmission to UE-B and UE-C. As shown in FIG. 6, the UE-B uses COT initiated by UE-A in two slots.

UE-B resumes the COT initiated by UE-A before scheduled resource with Type 2 LBT and performs unicast SL transmission to UE-C.

### Embodiment B

For Mode 1 or Mode 2 resource allocation, in order to support multi-consecutive slots communications in a COT, at least one of the following types of information can be generated and transmitted by Tx UE, which is carried in SCI, e.g., first stage SCI or second stage SCI, MAC-CE, or PC5-RRC.

### Embodiment B-1: Resource Reservation Information of Multiple Consecutive Slots

The reserved resource(s) includes the location of a starting slot, ending slot, or a length of consecutive slots. The reserved resource(s) can be indicated based on a row index associated with a preconfigured look-up table. Each row index can map to corresponding parameters associated with a set of multiple consecutive slots. The reserved resource(s) for multiple consecutive slots can be used for indicating:
One shot SL burst transmission of initial transmission or re-transmission of one or more than one TB based on dynamic or semi-static resource scheduling. Determination or selection of multiple consecutive slots can be realized based on
   Dynamic resource scheduling with an extended resource structure of candidate resources, each candidate resource includes multiple consecutive slots.
   Dynamic resource scheduling with a single slot resource structure of candidate resources, the set of multiple consecutive slots is generated by opportunistically selecting one set of consecutive slots from the list of available candidate resources.
   Semi-static resource scheduling with proper selection of resource reservation interval (RRI) value and SL resource reselection counter.
Periodic SL burst transmission of initial transmission or re-transmission of one or more than one TB based on semi-persistent scheduling. Periodic SL burst transmission is a periodic transmission of SL bursts, each SL burst carries one or more than one TB over multiple consecutive slots. The interval between consecutive SL bursts is determined by resource reservation interval (RRI) For scheduling more than one TB transmitted within a SL burst of periodic SL burst transmission, the resource reservation scheme can be similar to the case of one shot SL burst transmission.

With reference to FIG. 2, in some embodiments of the disclosure, each one of the resource candidates is a set of multiple consecutive slots.

With reference to FIG. 2, in some embodiments of the disclosure, each one of the resource candidates represents a single slot, and the resource of the set of multiple consecutive slots comprises slots consecutive in a time domain.

With reference to FIG. 2, in some embodiments of the disclosure, each slot within the set of multiple consecutive slots is randomly selected from the resource candidates.

With reference to FIG. 2, in some embodiments of the disclosure, the resource reservation information includes information related to the length of multiple consecutive slots. In some embodiments of the disclosure, the resource reservation information is transmitted in first stage SCI of a PSCCH. In some embodiments of the disclosure, a SCI format of the first stage SCI carries resource information of the set of multiple consecutive slots.

### Embodiment B-2: Resource Structure of the Multiple Consecutive Slots Scheduling

The reserved multiple consecutive slots comprise one or more than one PSCCH, each PSCCH schedules one or more than one PSSCH.
   The one or more than one PSSCH corresponds to the same TB or different TBs.
At least one of the one or more than one PSCCH includes a first stage SCI,
At least one of the one or more than one PSSCH includes a second stage SCI.
Examples of a constitution for a set of multiple consecutive slots can be the following.
   A first stage SCI is carried in the PSCCH of the first slot of multiple consecutive slots, which can schedule more than one PSSCHs for the same TB or different TBs in the multiple consecutive slots.
   A second stage SCI is carried in one of more than one PSSCH for the same TB transmission in the multiple consecutive slots.
   A second stage SCI is carried in each of more than one PSSCH, wherein each PSSCH corresponds to a TB, in the multiple consecutive slots.
A second stage SCI comprises at least one of the following types of information for the corresponding PSSCH.
   Source ID or destination ID.
   New data indicator (NDI), redundancy version (RV), or HARQ process ID of the TB carried in the PSSCH.
   Whether HARQ feedback is enabled for the corresponding PSSCH.
A first stage SCI comprises at least one of the following indications, and the associated parameters can be preconfigured by gNB.
   Resource reservation indication
      The range of a resource reservation for a future transmission is determined by at least one of the following:
         The length of COT initiated by the UE transmitting the first stage SCI.
         A restricted time window.
         The size or duration of the restricted time window can be preconfigured by gNB or determined based on the maximum length of a COT.
      UE can reserve one or more than one set of multiple consecutive slots within a restricted time window for future transmission.
   The number of resources reserved for a TB, including initial transmission and retransmissions.
   The number of TBs and corresponding reserved resources for each TB indicated in the resource reservation information.

### Embodiment B-3: Restrictions on Performing Multi-Consecutive Slots Transmission

An initiating UE can indicate whether a responding UE can perform multi-consecutive slots transmission with a COT based on at least one of the following schemes:
An explicit indication for activating or inactivating multi-consecutive slots transmissions.
Only the responding UE receiving initiating UE's transmission can perform multi-consecutive slots transmissions.
   The responding UE qualified for receiving initiating UE's transmission can be determined based on UE ID or destination ID.
Only the responding UE with an equal or smaller CAPC value than the CAPC value of the UE initiating the COT can perform multi-consecutive slots transmissions.
Only the responding UE with a higher priority TB, e.g., compared to a preconfigured priority threshold, can perform multi-consecutive slots transmissions.
Only the responding UE with lower latency requirement, e.g., based on Packet Delay Budget (PDB), can perform multi-consecutive slots transmissions.
Only the target receiver of a Tx UE's transmission can perform multi-consecutive slots transmissions.
   For a Tx UE, including an initiating UE or a responding UE, the target receiver (Rx UE) of the Tx UE could be the UE that matches the at least one of the following conditions
      The Rx UE is capable of detecting Tx UE's first stage SCI in PSCCH.
      Rx UE's ID matches the destination ID indicated in the second stage SCI of PSSCH.
         The destination ID could be a UE-specific ID of a single target UE in unicast transmission or a group-specific ID of a group of target UEs in groupcast transmission.
      Rx UE's ID matches an ID indicated in the first stage SCI, the ID is defined for one or more than one UE qualified for sharing the COT.
   For an initiating UE acts as a Tx UE, the target receiver (Rx UE) of the Tx UE could be the UE that matches the at least one of the following conditions
      The priority of the traffic associated to the Rx UE is equal or higher than the priority of the traffic associated to the Tx UE.
         The priority level can be represented in terms of a CAPC value.
         The Tx UE's CAPC can be indicated in the first stage SCI, second stage SCI, MAC CE, or PC5-RRC.
      For a responding UE acts as a Tx UE of, at least the UE initiating the COT is the target receiver of the responding UE.
         The Tx UE can identify the initiating UE based on the source ID indicated in the COT sharing information in the first stage SCI or in the second stage SCI.
An initiating UE can indicate at least one of the following parameters to limit the transmission location or duration of the multi-consecutive slots transmissions.
Starting time, ending time, duration, or a maximum number of consecutive slots for multi-consecutive slots transmission performed by the responding UE.
   The value of the maximum number of consecutive slots can be determined according to subcarrier spacing (SCS) configuration.
Applicability of multi-consecutive slots transmissions can be preconfigured per resource pool or per RB set.

With reference to FIG. 2, in some embodiments of the disclosure, the reserved resource is valid for sidelink transmission if the UE has received UE identity information from a second UE; wherein the second UE has initiated a channel occupancy time (COT), the COT covers the reserved resource, and the UE identity information matches an identity of the UE. The UE identity information is a destination ID of the second UE, and the destination ID is transmitted in second stage SCI from the second UE. In some embodiments of the disclosure, the UE identity information transmitted by the second UE is derived from information carried in the resource reservation information.

With reference to FIG. 2, in some embodiments of the disclosure, the reserved resource is valid for sidelink transmission if a receiver of the sidelink transmission over the reserved resource is a second UE, wherein the second UE has initiated a COT, and the COT covers the reserved resource. The UE derives a UE identity of the second UE, and a destination ID of the sidelink transmission from the UE is a UE identity of the second UE.

With reference to FIG. 2, in some embodiments of the disclosure, the reserved resource is valid for sidelink transmission if the UE is a target receiver of a second UE, where in the second UE initiates a COT and the COT covers the reserved resource, and a UE identity of the UE matches a destination ID of the second UE.

With reference to FIG. 2, in some embodiments of the disclosure, the transmission priority of each PSSCH transmitted over multiple consecutive slots in the reserved resource is equal to or higher than a transmission priority associated with a traffic type of the second UE. In some embodiments of the disclosure, a CAPC value associated with each PSSCH transmitted over multiple consecutive slots in the reserved resource is equal or lower than a CAPC value associated with the second UE. In some embodiments of the disclosure, the CAPC value associated with PSSCH in each slot within the multiple consecutive slots in the reserved resource is transmitted in second stage SCI.

With reference to FIG. 2, in some embodiments of the disclosure, the selected resource of multiple consecutive slots is dropped if the channel access scheme for accessing the reserved resource fails. In some embodiments of the disclosure, the selected resource of multiple consecutive slots is dropped if the reserved resource is not valid for sidelink transmission. In some embodiments of the disclosure, the UE (e.g., UE 10d) performs reselection for another set of multiple consecutive slots if the channel access scheme for accessing the reserved resource fails. The UE (e.g., UE 10d) performs reselection for a resource of another set of multiple consecutive slots if the reserved resource is not valid for sidelink transmission.

### Embodiment B-4

With reference to FIG. 7, an example showing steps of Mode 2 resource allocation for multi-consecutive slots transmission is detailed in the following.
UE-A performs Mode 2 resource allocation to exclude resource reserved by other UEs and then select a resource for multi-consecutive slots transmission based on a predetermined rule.
UE-A successfully initiates a COT based on Type 1 LBT before the selected resource.
   UE-A reserves consecutive slots for SL transmission to UE-B with resource reservation information located in the first stage SCI in PSCCH A-1.
      The resource reservation information can reserve resource at least for the first set of consecutive slots, i.e., slot 1 to slot 3, transmission.
      The resource reservation information can also reserve resource for the second set of consecutive slots, i.e., slot 6 to slot 9.
   UE-A shares the COT to other UEs with COT sharing information carried in the first stage SCI.
   UE-B receives the COT sharing information and determines itself as a qualified UE for utilizing the COT shared by the UE-A.
      A UE qualified for utilizing the COT shared by UE-A can be determined based on at least one of the following:
         The UE can detect PSCCH and successfully decode the first stage SCI.
         An ID carried in the first stage SCI or a second stage SCI can match the UE's ID.
   UE-B utilizes the COT shared by UE-A after successful Type 2 LBT and reserves resource, i.e., slot 4 and slot 5, for SL transmission.
      The target receiver of UE-B's transmission at least includes the initiator UE, i.e., UE-A.
         The UE-B can identify UE-A as the initiator UE based on the source ID indicated in the second stage SCI.
   If the resource in slot 6 to slot 9 has been reserved in PSCCH A-1
      Upon successful Type 2 LBT before the reserved resource, UE-A can resume transmission on the COT.
   Otherwise, UE-A reserves slot 6 to slot 9 and transmits the resource reservation information in the first stage SCI in PSCCH A-2.
      Upon successful Type 2 LBT before the reserved resource, UE-A can resume transmission on the COT.

With reference to FIG. 2, in some embodiments of the disclosure, the UE is not a target receiver for receiving sidelink data from the second UE.

With reference to FIG. 2, in some embodiments of the disclosure, the reserved resource is valid for sidelink transmission if the UE has initiated a COT covering the reserved resource. In some embodiments of the disclosure, the initiated COT is shared to a second UE, and a priority level of traffic transmitted by the UE over the reserved resource is higher than a priority level of traffic transmitted by the second UE. In some embodiments of the disclosure, the initiated COT is shared to a second UE, and the channel access scheme adopted by the UE to access the reserved resource is Type 2 listen before talk (LBT).

### Embodiment C: Sensing Window Parameter

For Mode 2 resource allocation in NR V2X, the UE (e.g., UE 10d) decodes first stage SCIs received from other UEs (e.g., UE 10c) in the sensing window during the sensing window to identify non-reserved resources. The sensing window is an interval defined by the range of slots [n-T0, n-Tproc,0), where n is the point of triggering resource selection upon arrival of a data packet. T0 is expressed in terms of number of slots, which has an equivalent value of 1100 ms or 100 ms depending on the SCS configuration. Tproc,0 is the time required to complete the sensing procedure with value of {1, 2, 2, 4} slot for SCS of {15, 30, 60, 120} kHz, respectively. The UE also measures the RSRP of the transmissions associated with the first stage SCIs. Information of reserved resource in the first stage SCI and corresponding RSRP measurements are used for determining candidate resources during the selection window.

For SL-U, at least one of the above parameters can be further determined based on at least one of following schemes:
The value of T₀, T_{proc,0}, or a range of a sensing window in addition to [n-T₀, n-T_{proc,0}), can be determined based on at least one of the following parameters:
   CAPC value, COT location or maximum COT duration.
   Channel sensing location or required duration for performing Type 1 of Type 2 LBT.
   SCS configured for the resource pool or RB set.
The RSRP measurement of the transmissions associated to the first stage SCIs including the RSPR measurement over PSCCH carrying the first stage SCI or the scheduled PSSCH in one or more than one slot of the multi-consecutive slots.

With reference to FIG. 2, in some embodiments of the disclosure, the selection of the resource of the set of multiple consecutive slots is based on reference signal received power (RSRP) measurements of physical sidelink control channel (PSCCH) or scheduled physical sidelink shared channel (PSSCH) over each slot of the resource candidates.

### Embodiment D-1: Selection Window Parameter

For Mode 2 resource allocation in NR V2X, if resource selection is triggered at point n, a selection window is defined for a UE to select candidate resources for transmitting a TB. The selection window includes slots in the range of [n+T₁, n+T₂]. T₁ is the processing time of slots required to identify candidate resources and perform resource selection. T₁ is equal to or smaller than T_{proc,1}. T_{proc,1} equals to 3, 5, 9 or 17 slots for a SCS of 15, 30, 60 or 120 kHz, respectively. The value of T₂ is in the range of T₂ₘᵢₙ≤T₂≤PDB, where PDB is the Packet Delay Budget. The value of T₂ₘᵢₙ depends on the priority of the TB and the SCS. Possible values of T₂ₘᵢₙ include {1, 5, 10, 20}*2^{μ} slots, where μ=0, 1, 2, and 3 corresponds to the SCS of 15, 30, 60, and 120 kHz, respectively.
For SL-U, at least one of the above parameters can be further determined based on at least one of the following schemes:
   The value of T₁ can further incorporate required channel sensing time to complete Type 1 or Type 2 LBT procedure.
      For Type 1 LBT, channel sensing time can also be determined by CAPC value or associated parameters adopted by the UE to perform Type 1 LBT.
   The value of T₂ can be determined based on a CAPC value, COT location or maximum COT duration of the UE reserving the resource for one or more than one TB transmission.
      The T₂ can be a function of the maximum COT duration of the CAPC value belonging to the UE or at least one of the resource locations of the reserved resources.
         For example, the value of T₂ equals to a summation of the time point at the beginning of the earliest reserved resource and the maximum COT duration.
         For example, the value of T₂ is restricted by the minimum value of {PDB, maximum COT}.

### Embodiment D-2: Resource Selection Parameter

For Mode 2 resource allocation in NR V2X, during the selection window, resource selection can be based on dynamic or semi-persistent schemes. In NR V2X, the dynamic scheme selects resources for a TB and can only reserve resources for the initial transmission and retransmissions of that TB, while the semi-persistent scheme selects resources for initial transmission and retransmissions of several TBs.

In NR V2X, two steps resource allocation is adopted. In Step 1, UE (e.g., UE 10c or 10d) excludes the candidate resources in the selection window due to half-duplex limitation, wherein resources are excluded when a UE (e.g., UE 10d) cannot sense the reservations from other UEs (e.g., UE 10c) announced in the first stage SCIs while the UE is transmitting during the sensing window. In addition, UE (e.g., UE 10d) evaluates the available resources based on the resource reservation information in the first stage SCIs from other UEs (e.g., UE 10c) during the sensing window. And the resources are excluded if measured RSRP over the PSCCH carrying the first stage SCI or associated PSSCH scheduled by PSCCH is higher than an SL-RSRP threshold. To ensure the percentage of available candidate resources in the selection window is at least equal to X%, SL-RSRP threshold can be increased by 3 dB and the Step 1 process is repeated iteratively to meet the X percentage requirement. Depending on the priority of traffic for transmission, possible values of X can be 20, 35 or 50. In Step 2, the UE (e.g., UE 10d) randomly selects the SL resource from the list of available candidate resources to perform initial transmission and re-transmissions of a TB.

For semi-persistent schemes, the time period between the resources selected for the transmission of consecutive TBs is defined by the Resource Reservation Interval (RRI), the number of TBs for consecutive TBs is determined by an SL resource reselection counter. The possible values of the RRI are {0, [1:99], 100, 200, 300, 400 500, 600, 700, 800, 900, 1000} ms. The frequency domain resources of each consecutive TBs are the same. The UE can select the RRI autonomously based on the characteristics of the traffic type. The number of SL resource reselection counter is randomly determined within an interval according to the selected RRI value. For RRI≥100 ms, the interval is [5, 15], and if RRI<100 ms, the interval is [5*(100/max(20,RRI)),15*(100/max(20,RRI))].

In SL-U, for Mode 2 resource allocation, a percentage of available candidate resources in the selection window X% of the SL-RSRP threshold can be determined based on CAPC value of the traffic transmitted by Tx UE.

In SL-U, for Mode 2 resource allocation, in order to support multi-consecutive slots transmission for a TB or multiple TBs. At least one of the above parameters can be further determined based on at least one of the following schemes.

The SL resource reselection counter can be determined by a UE with a specific value.
The number of TBs transmitted in the multi-consecutive slots can be determined based on a newly defined parameter or the SL resource reselection counter.
The number of slots in the multiple consecutive slots can be determined based on a newly defined parameter or the SL resource reselection counter.

The Resource Reservation Interval (RRI) can be determined by a UE with a specific value.
The Resource Reservation Interval (RRI) can be set to a value that leads to consecutive slots transmissions.
The value of Resource Reservation Interval (RRI) can be determined based on a CAPC value or the maximum length of COT.
The value of Resource Reservation Interval (RRI) can be determined based on required time duration for performing Type 1 or Type 2 LBT.

For example, RRI is larger than the required time duration for performing Type 1 or Type 2 LBT.

The frequency domain resource or modulation and coding scheme (MCS) in each slot for a corresponding TB transmission can be different in the multi-consecutive slots transmission.

Resource locations of the initial and retransmissions of one or more than one TB can be selected to be transmitted in consecutive slots.

With reference to FIG. 2, in some embodiments of the disclosure, the length of multiple consecutive slots is derived based on a parameter configured for selection of the resource of the set of multiple consecutive slots in the resource selection procedure.

With reference to FIG. 2 and embodiment F, in some embodiments of the disclosure, the value of the parameter is associated with a sidelink resource pool.

### Embodiment E: Resource Selection for Multiple Consecutive Slots

In NR V2X, for dynamic scheduling scheme based on Mode 2 resource allocation, resources can be only reserved for a TB, including initial transmission and the retransmissions of that TB, and the granularity of candidate resource is defined by a slot in time and contiguous sub-channels in frequency.

In SL-U, in order to support multi-consecutive slots transmission for the dynamic or semi-static scheduling scheme based on Mode 2 resource allocation, the resource structure of a candidate resource can be defined as one of the following.

(1). Resource structure of a candidate resource can be multiple consecutive slots in time, wherein each slot can have one or more than one interlace. UE (e.g., UE 10c or 10d) can select among multiple sets of multiple consecutive slots based on at least one of the following schemes:
Randomly selecting.
Selecting based on a latency requirement, TB size or priority level, e.g., a CAPC value, of the traffic type.

(2). Resource structure of a candidate resource is a slot in the time domain, wherein the slot can have one or more than one interlace. However, different from the Step 2 of resource selection in NR V2X, wherein the UE randomly selects the SL resource from the list of available candidate resources. In SL-U, in order to support multi-consecutive slots transmission, Step 2 resource selection can be conducted in one of the following schemes.
UE (e.g., UE 10c or 10d) can opportunistically select consecutive slots from the list of available candidate resources to form a multi-consecutive slots transmission.
Selection of a set of multiple consecutive slots among multiple sets of available multiple consecutive slots can be determined based on:
   Random selection.
   A Latency requirement, TB size or priority level e.g., CAPC value, of the traffic type.
UE (e.g., UE 10c or 10d) can select a set of multiple consecutive slots, of which a length in terms of a number of slots, starting slot location or ending slot location can meet a traffic type requirement.

With reference to FIG. 2, in some embodiments of the disclosure, length of multiple consecutive slots is derived based on a performance requirement of a sidelink traffic type.

### Embodiment F: Multi-Consecutive Slots Constitution

In SL-U, in order to support multi-consecutive slots transmission based on Mode 1 or Mode 2 resource allocation, the resource structure to constitute one or more than one set of multiple consecutive slots for one or more than one TB can be one of the following. Wherein a TB can associate with one PSSCH or more than one PSSCH, i.e., PSSCH repetition or blind retransmission.

For a single TB case, initial transmission and blind retransmissions of a TB can be carried in the same set of multiple consecutive slots.

In this case, Type A or Type B repetition for PUSCH in NR-U can be adopted for multi-consecutive slots transmission of a TB.

For a single TB case with SL-HARQ feedback, initial transmission and retransmissions of a TB can be carried in different sets of multiple consecutive slots.

For multiple TBs case, initial transmissions of multiple TBs can be carried in the same set of multiple consecutive slots.

For multiple TBs case, each TB can be carried by one or more than one consecutive slot of the multiple consecutive slots.

For multiple TBs case, each TB can be carried in a slot of multiple consecutive slots with the same number of interfaces or different numbers of interlaces. Wherein the index value of an interlace in each slot or frequency location of an index in each slot can be the same or different.

For multiple TBs case, each TB can be carried in consecutive slots, different set of consecutive slots can have the same number of interlaces or different numbers of interlaces. Wherein index value of an interlace or frequency location of an index in different sets of consecutive slots can be the same or different.

For single TB and multiple TBs case, the length of consecutive slots for initial transmission or retransmission can be the same or different.

For single TB and multiple TBs case, the number of interlaces or interlace index for initial transmission or retransmission can be the same or different.

The maximum slot number of multiple consecutive slots can be preconfigured for a resource pool or an RB set.

In multiple consecutive slots, for a slot including more than one interlaces, the index of interlaces can be continuous and the number of interlaces selected by UE (e.g., UE 10c or 10d) depends on the size of TB or SCI being carried in the slot of the multiple consecutive slots. A maximum number of interlaces for a slot can be preconfigured for a resource pool or an RB set.

With reference to FIG. 2, in some embodiments of the disclosure, the selected resource of the set of multiple consecutive slots is for transmission of a transport block (TB). For example, the selected resource of the set of multiple consecutive slots is for initial transmission or re-transmission of the TB or repetitions of the TB.

With reference to FIG. 2, in some embodiments of the disclosure, resource of another set of multiple consecutive slots is selected by the UE, the initial transmission of the TB is conveyed in the selected resource of the set of multiple consecutive slots, and the re-transmission of the TB is conveyed in the resource of the another set of multiple consecutive slots.

With reference to FIG. 2, in some embodiments of the disclosure, resource of another set of multiple consecutive slots is selected by the UE, and the resource of the another set of multiple consecutive slots is for transmission of another TB. In some embodiments of the disclosure, an interlace index or a number of interlaces assigned for PSSCH transmission are the same in each slot within the multiple consecutive slots.

With reference to FIG. 2, in some embodiments of the disclosure, frequency domain resource scheduled by the UE for PSSCH transmission are the same across slots within the set of multiple consecutive slots.

With reference to FIG. 2, in some embodiments of the disclosure, each slot within the set of multiple consecutive slots is for transmission of a TB.

With reference to FIG. 2, in some embodiments of the disclosure, frequency domain resources scheduled by the UE for PSSCH transmission in different slots within the set of multiple consecutive slots are independent. Interlace indexes or numbers of interlaces assigned for PSSCH transmission in different slots within the set of multiple consecutive slots are independent.

### Embodiment G: Dynamic Scheduling for a TB

In SL-U, in order to support multi-consecutive slots transmission for a TB based on Mode 1 or Mode 2 resource allocation, the scheduling scheme for the selected multiple consecutive slots can be the following.
The dynamic scheduling of PSSCH can be based on the Type A or Type B repetition similar to NR-U for PUSCH.
   For Type B repetition, if a nominal repetition crosses a slot boundary or one or more than one invalid symbols, the nominal repetition can be skipped or can be segmented into one or more actual repetitions. E.g., a nominal repetition can be segmented into a first actual repetition located before the invalid symbol(s) and a second actual repetition located after the invalid symbol(s).
   Invalid symbol(s) includes at least one of the following:
      A guard symbol at the end of a SL slot.
      A guard symbol before the AGC symbol of PSFCH in a SL slot
      Any symbol of a slot configured not to be used for SL communication by gNB.
   The actual repetition can be skipped if the actual repetition is located after the invalid symbol(s).
   If an actual repetition only contains one symbol, e.g., an orphan symbol, due to segmentation, then the following transmission scheme for the orphan symbol can be adopted:
      The orphan symbol is not transmitted.
      The orphan symbol is transmitted as a DMRS symbol.
      The orphan symbol is transmitted in a way similar an AGC symbol, i.e., a copy of the next symbol in the same slot.
      The orphan symbol is transmitted as a CPE of the following symbol.
Indication of time or frequency resource location for each repetition and number of nominal repetitions within the multiple consecutive slots can be indicated in the SCI, either the first stage SCI or the second stage SCI.

### Embodiment H-1: Dynamic Scheduling for Multiple TBs

In SL-U, in order to support multi-consecutive slots transmission for multiple TBs based on Mode 1 or Mode 2 resource allocation, the scheduling scheme for the selected multiple consecutive slots can be one of the following.

(1). A first stage SCI in a PSCCH is associated with one or more than one second stage SCI. First stage SCI indicate at least one of the following information regarding the one or more than one second stage SCI:
Slot location of each second stage SCI (e.g., in terms of a slot offset relative to the slot carrying the first stage SCI).
Resource location of each second stage SCI (e.g., in terms of an interlace index or based on a default interlace index, e.g., the lowest index).
Size of each second stage SCI (e.g., in terms of the number of interlaces).
SCI format of each second stage SCI.

(2). A first stage SCI in a PSCCH contains control information associated with one or more than one PSSCH. First stage SCI can indicate at least one of the following information regarding the one or more than one PSSCH.
MCS of each PSSCH. The MCS is determined based on an index associated to an MCS table. The type of MCS table can be determined based on
   An indication in the first stage SCI.
   Preconfigure for a resource pool or an RB set.
   Associated with the priority of PSCCH.
Slot location of each PSSCH, including time location of initial transmission or retransmissions of one or more than one TB. The slot location of each PSSCH can be represented, for example, in terms of a slot offset relative to the slot carrying the first stage SCI or in terms of RRI or SL resource reselection counter.
Resource location of each PSSCH, including frequency location of initial transmission or retransmissions of one or more than one TB. The resource location of each PSSCH can be represented, for example, in terms of an initial interlace index.
Size of each PSSCH (e.g., in terms of the number of interlaces).
Priority of each PSSCH (e.g., in terms of CAPC).
DMRS pattern of each PSSCH. The DMRS pattern is determined based on an index associated to a group of DMRS patterns. The number of ports supported the DMRS pattern can also be indicated to determine the number of layers supported for PSSCH transmission.

Multiple PSSCHs carrying different TBs can be scheduled in a PSCCH in the first slot of the multiple consecutive slots if the number of interlaces or the size of an interlace carrying a PSCCH is large enough. Otherwise, more than one PSCCHs can be deployed in more than one slot of the multiple consecutive slots, each of the PSCCH can schedule one or more than one PSSCHs.

(3). A second stage SCI can be carried in each of the one or more of the multiple PSSCHs. The association between the first stage SCI, second stage SCI and one or more than one PSCCH can be the following:
A second stage SCI is associated with a PSSCH which carries the second stage SCI. Each PSSCH is associate with a TB.
A second stage SCI is associated to more than one PSSCH. Each PSSCH of the more than one PSSCH carries the same TB or different TBs.
Second stage SCI can indicate at least one of following information for each associated PSSCH:
   Activation of SL-HARQ feedback of each associated PSSCH.
   CSI feedback request.
   Source ID and Destination ID of each associated PSSCH.
   HARQ-ID, NDI, or RV of each associated PSSCH.
   Unicast, groupcast, or broadcast of each associated PSSCH.

With reference to FIG. 2, in some embodiments of the disclosure, a first stage sidelink control information (SCI) is carried in a PSCCH of the first slot within the set of multiple consecutive slots. The first stage SCI is associated with more than one second stage SCI in the set of multiple consecutive slots. The first stage SCI contains control information associated with more than one PSSCH in the set of multiple consecutive slots.

### Embodiment H-2

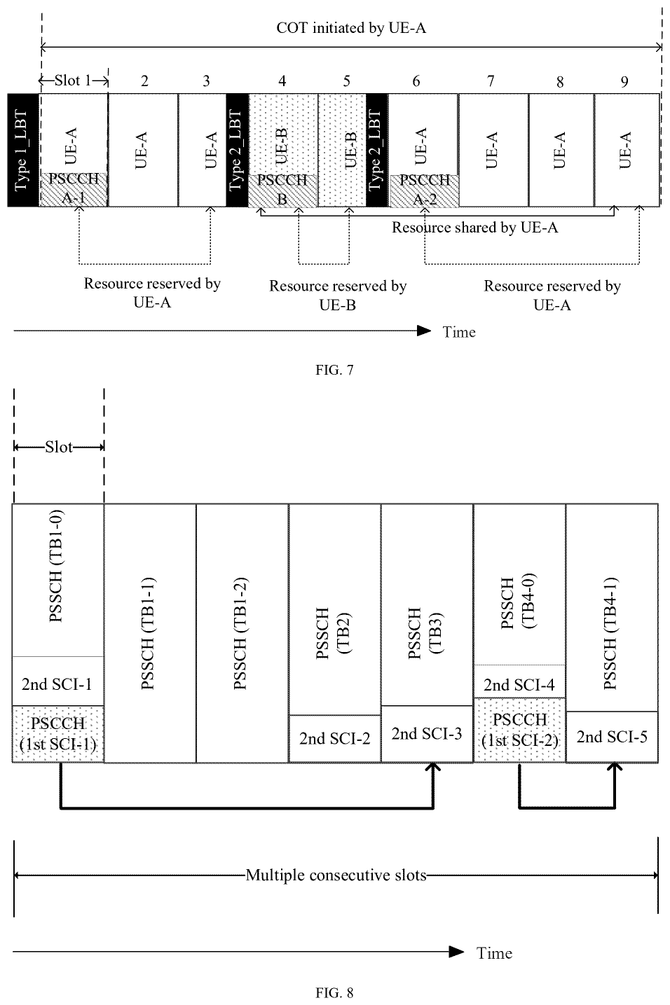

With reference to FIG. 8, examples of relationships between the first stage SCI in PSSCH, the second stage SCI, PSSCH and TBs are detailed in the following.
2 first stage SCIs in the two PSCCH of the multiple consecutive slots, i.e., 1^{st} SCI-1 and 1^{st} SCI-2.
   1^{st} SCI-1 in a PSCCH of the first slot is associated to 3 TBs, i.e., TB1, TB2 and TB3.
      1^{st} SCI-1 is associated with 3 second stage SCIs, i.e., 2^{nd} SCI-1, 2^{nd} SCI-2, and 2^{nd} SCI-3
         TB1 is transmitted in 3 PSSCHs, each corresponds to initial transmission, i.e., TB1-0, first retransmission, i.e., TB1-2, and second retransmission, i.e., TB1-3.
         2^{nd} SCI-1 carries decoding information for TB1.
         TB2 is transmitted in the PSSCH of the fourth slot without retransmission.
         2^{nd} SCI-2 carries decoding information for TB2.
         TB3 is transmitted in the PSSCH of the fifth slot without retransmission.
         2^{nd} SCI-3 carries decoding information for TB3.
   1^{st} SCI-2 in a PSSCH of the sixth slot is associated with 1 TB, i.e., TB4.
      1^{st} SCI-2 is associated with 2 second stage SCIs, i.e., 2^{nd} SCI-4 and 2^{nd} SCI-5.
         TB4 is transmitted in two PSSCHs, where one of the two PSSCHs corresponds to an initial transmission, i.e., TB4-0, and the other one of the two PSSCHs corresponds to a first retransmission, i.e., TB4-1
         2^{nd} SCI-3 carries decoding information for TB4-0.
         2^{nd} SCI-4 carries decoding information for TB4-1.

### Embodiment I-1: Semi-Static Scheduling for Multiple TBs

In SL-U, in order to support multi-consecutive slots transmission for multiple TBs transmission in Mode 2 resource allocation, the scheduling scheme for the selected multiple consecutive slots can be one of the following.
Consecutive slots can be indicated based on the semi-static scheduling scheme of Mode 2 resource allocation with proper selection of resource reservation interval (RRI).
   RRI value can be set to, such that a set of consecutive slots can be created
      E.g., 1 slot or 1 ms for 15 kHz SCS. In this case, each slot can correspond to a TB transmission.
   RRI value can also be set to more than one slot, e.g., value K. In this case, in order to keep a burst of consecutive slots transmission, each TB can map to K slots. That is, the unit of resource selection for a TB in the selection window can be K consecutive slots.
      E.g., K=2 slot or 2 ms for 15 kHz SCS. In this case, a TB is transmitted in 2 consecutive slots, i.e, with repetition.
The number of multiple consecutive slots can be determined based on the selected value of SL resource reselection counter, e.g., value S.
   If a TB is transmitted on one slot. Since SL resource reselection counter is decremented by one after transmitting a TB, there are totally S TBs to be transmitted in the multiple consecutive slots of length S.
   If a TB is transmitted on more than one slot, e.g., value K, and SL resource reselection counter is decremented by one after transmitting a TB, then there are totally S TBs to be transmitted in the multiple consecutive slots of length K*(S+1).
   The maximum value of SL resource reselection counter can be determined based on the value of maximum COT, i.e., mCOT, associated with a CAPC value.
When the SL resource reselection counter equals zero, the following transmission behavior can be considered.
   For one shot SL burst transmission based on dynamic scheduling, the transmission of multiple consecutive slots is completed.
   For periodic SL burst transmission based on semi-static scheduling, UE can select a new set of interlaces for next round of SL burst transmission.
      Selection of the new set of interlaces can be determined based on
         A transmission with probability (1−P), where value P can be preconfigured within a probability range.
         The probability range can be different for different priorities of traffic.
      The SL resource reselection counter is also reset to an original value or possibly another value for counting down in the next round.

### Embodiment I-2

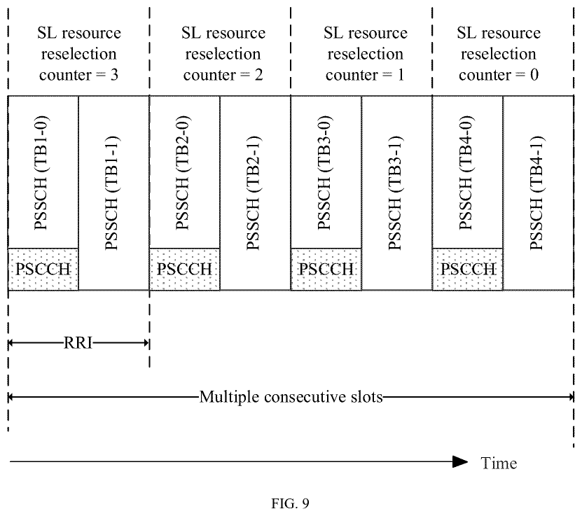

With reference to FIG. 9, an example of multiple consecutive slots generation based on configuration of RRI and SL resource reselection counter is detailed in the following.
4 TBs are transmitted in the multiple consecutive slots.
   Each TB is transmitted on 2 PSSCHs for initial transmission and retransmission of the TB.
8 slots are included in the multi-consecutive slots transmission based on the following settings.
   RRI is set to 2 slots.
   SL resource selection counter is set to 3.

### Embodiment J: Channel Sensing Duration

In SL-U, a time duration for channel sensing is required for accessing the channel before transmitting SL data on reserved resource based on Mode 1 or Mode 1 resource allocation or selected resource based on Mode 2 resource allocation.

The size of channel sensing duration for Type 1 LBT is determined based on a contention window size associated with a CAPC value adopted by the UE. The size of channel sensing duration needs to consider following two cases.
The CAPC value adopted by the UE reserving a SL resource in the first stage SCI.
The CAPA value adopted by the UE selecting a SL resource in the selection window.

In order to avoid inter-blocking between UEs due to collision between the resource reserved by one UE and the resource selected by the other UE or the collision between the resources selected by a UE. In the candidate resource selection step of Mode 2 resource allocation during the selection window, at least one of the following gap length needs to be ensured.
The gap length between the time triggering resource selection and the start of the earliest selected resource needs to be large enough to accommodate channel sensing duration for Type 1 LBT channel access.
The gap length between the end of a selected resource and the start of the next selected resource need to be large enough to accommodate channel sensing duration for Type 1 LBT channel access.
   An additional gap needs to be created in order to include SL-HARQ round trip time (RTT) of consecutive selected resources if SL-HARQ feedback is activated.
The gap length between the end of a reserved resource and the start of a selected resource needs to be large enough to accommodate channel sensing duration for Type 1 LBT channel access.
   The gap length between the end of a selected resource and the start of a reserved resource needs to be large enough to accommodate channel sensing duration for Type 1 LBT channel access.

In order to avoid inter-blocking between UEs due to collision between a reserved or selected resource and time duration of channel access, the gap length can be set to a value determined by the largest contention window among all CAPC values.

With reference to FIG. 2, in some embodiments of the disclosure, the selection of the set of multiple consecutive slots is based on a judgement of whether a time gap length between a resource candidate and a resource reserved by another UE is larger than a threshold value. In some embodiments of the disclosure, a parameter related to the threshold value of gap length is configured for selection of resource candidates. The threshold value of gap length is configured according to a time duration of Type 1 LBT performed by the UE. The threshold value of gap length is configured according to a channel access priority class (CAPC) value associated with a sidelink traffic type transmitted by the UE. With reference to Embodiment K, in some embodiments of the disclosure, the UE (e.g., UE 10d) selects a resource of another set of multiple consecutive slots if the gap length is less than threshold value or the threshold value is updated.

### Embodiment K: Resource Reselection

In SL-U, after the steps of resource selection in a selection window has been completed for Mode 2 resource allocation. At least one of the selected resources can be re-selected if one of the following conditions is satisfied.
The UE fails to access a channel based on Type 1 or Type 2 LBT before a selected resource. Failure of accessing a channel can result from at least one of the following conditions.
   The channel is assessed to be occupied after UE completes LBT channel access process.
   UE cannot complete the LBT channel access process before the selected resource due to not having enough time for performing channel access.
The size of selected resource cannot match the size or performance requirement of a TB waiting for transmission. The unmatched size of the selected resource can be one of the following parameters.
   The number of interlaces of the selected resource.
   The length of multiple consecutive slots of the selected resource.
   The starting or ending location of the selected resource.

### Embodiment L: Resource Dropping

In SL-U, at least one of the selected or reserved resources can be dropped if one of the following conditions is satisfied.
The UE fails to access the channel based on Type 1 or Type 2 LBT before a selected or reserved resource. Failure of accessing a channel can result from at least one of the following conditions.
   The channel is assessed to be occupied after UE completes an LBT channel access process.
   UE cannot complete the LBT channel access process due to not having enough time for performing channel access.
A selected or reserved resource is outside the coverage of COT initiated by a UE.
A selected or reserved resource is outside the coverage of COT being shared by a UE.
If SL-HARQ feedback of initial transmission or retransmission of a TB is ACKed, then the selected of reserved resource for remaining retransmissions can be dropped.

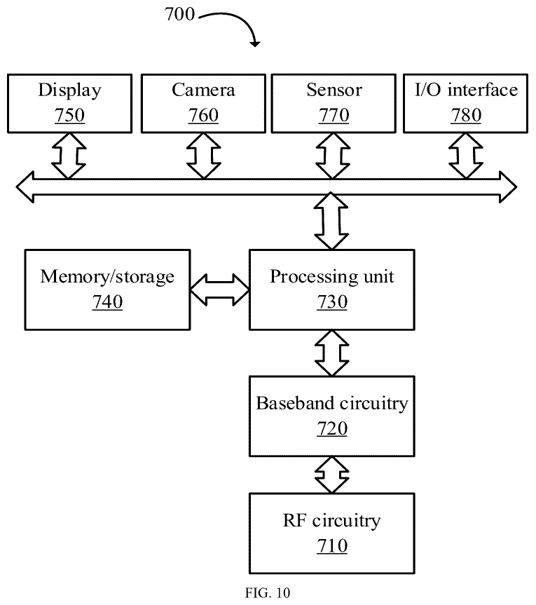

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to. one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method for execution by a user equipment (UE), comprising:
receiving resource reservation information from a second UE;
identifying a location of a reserved resource from the resource reservation information;
deriving a length of multiple consecutive slots for sidelink transmission;
selecting a resource of a set of multiple consecutive slots from resource candidates based on the length of multiple consecutive slots and the location of the reserved resource;
determining a location to initiate a channel occupancy time (COT) according to the location of the reserved resource; and
performing a channel access scheme to initiate the COT.

2. The wireless communication method of claim 1, wherein a time gap between the selected resource and the reserved resource is greater than a resource length threshold value.

3. The wireless communication method of claim 2, wherein the time gap is calculated from an end of the selected resource to a start of the reserved resource.

4. The wireless communication method of claim 3, wherein the time gap is before the reserved resource, and a value of the time gap is determined based on a priority value of the selected resource transmitted by the UE.

5. The wireless communication method of claim 3, wherein a parameter regarding whether to reserve the time gap between the selected resource and the reserved resource is configured for the UE.

6. The wireless communication method of claim 2, wherein the time gap is calculated from an end of the reserved resource to a start of the selected resource.

7. The wireless communication method of claim 6, wherein the time gap is after the reserved resource, and the value of the time gap is greater than a time duration necessary for the UE to perform channel access for the selected resource.

8. The wireless communication method of claim 1, wherein a location of the selected resource is determined based on a time point at which resource selection is triggered.

9. The wireless communication method of claim 1, wherein the length of multiple consecutive slots is determined according to a channel access priority class (CAPC) value of a corresponding traffic type.

10. The wireless communication method of claim 1, wherein the COT initiated by the UE covers the reserved resource.

11. The wireless communication method of claim 10, wherein the reserved resource is valid for transmission by the second UE if the COT initiated by the UE is shared with the second UE.

12. The wireless communication method of claim 11, wherein the second UE is distinct from a target UE for receiving traffic data from the UE over the selected resource.

13. The wireless communication method of claim 10, wherein the reserved resource is valid for transmission by the second UE when traffic priority of the second UE is equal to or greater than traffic priority of the UE.

14. The wireless communication method of claim 10, wherein the reserved resource is valid for transmission by the second UE if UE identity information sent from the UE to the second UE matches identity of the second UE.

15. A wireless communication method for execution by a user equipment (UE), comprising:
deriving a length of multiple consecutive slots for sidelink transmission;
selecting a resource of a set of multiple consecutive slots from resource candidates based on the length of multiple consecutive slots;
generating resource reservation information for indicating a reserved resource that is reserved for the selected resource of the set of multiple consecutive slots;
transmitting the resource reservation information to a second UE;
receiving channel occupancy time (COT) sharing information of a COT from the second UE; and
determining validity of the reserved resource.

16. The wireless communication method of claim 15, wherein the COT initiated by the second UE covers the reserved resource, and the reserved resource is valid for transmission by the UE.

17. The wireless communication method of claim 15, wherein the reserved resource is valid for transmission by the UE if the UE receives UE identity information from the second UE, and the UE identity information matches an identity of the UE.

18. The wireless communication method of claim 16, wherein the UE is distinct from a target UE for receiving traffic data from the second UE.

19. A wireless communication method for execution by a user equipment (UE), comprising:
deriving a length of multiple consecutive slots for a sidelink transmission;
selecting a resource of a set of multiple consecutive slots from resource candidates based on the length of multiple consecutive slots;
generating resource reservation information for indicating a reserved resource that is reserved for the selected resource of the set of multiple consecutive slots;
performing a channel access scheme to initiate a COT for initial data transmission; and
providing COT sharing information to a second UE for sharing the COT, wherein a resource location of a shared resource indicated by the COT sharing information is in front of a resource location of the reserved resource.

20. The wireless communication method of claim 19, wherein the UE is operable to resume data transmission over the reserved resource if the COT covers the reserved resource and Type 2 channel access for the reserved resource has been successfully performed by the UE.
